(19) United States
(12) Patent Application Publication
(10) Pub. No.: US 2008/0077500 A1
(43) Pub. Date: Mar. 27, 2008

(54) Systems and methods for third party sponsorship of a network event

(76) Inventors: Jonathon Linner, San Mateo, CA (US); Juho-Pekka Virolaine, Burlingame, CA (US); Rob Lawson, Burlingame, CA (US)

Correspondence Address: CARR & FERRELL LLP, 2200 GENG ROAD, PALO ALTO, CA, 94303, US

(21) Appl. No.: 11/897,266

(22) Filed: Aug. 28, 2007

Related U.S. Application Data
(60) Provisional application No. 60/823,754, filed on Aug. 28, 2006.

(51) Int. Cl. G06Q 30/00; G06F 17/30; G06F 17/40

(52) U.S. Cl. 705/14

(57) ABSTRACT

Systems and methods for third-party sponsorship of a network event are provided. An item is associated with a reverse auction. One or more marketing messages associated with a third party sponsor associated with the reverse auction are communicated to a user. An entry associated with the reverse auction is received from the user. The entry for the reverse auction is accepted.

### CROSS-REFERENCE TO RELATED APPLICATIONS

The present application claims the priority benefit of U.S. Provisional Patent Application Ser. No. 60/823,754, filed Aug. 28, 2006, titled “Systems and Methods for Third-Party Sponsors in a Networked Event;” U.S. patent application Ser. No. 11/602,917, filed Nov. 20, 2006, titled, “Systems and Methods for Using Points with a Network Event;” U.S. Provisional Patent Application Ser. No. 60/748,900, filed Dec. 10, 2005, titled “Systems and Methods for Using Points in a Reverse Auction;” U.S. Provisional Patent Application Ser. No. 60/748,963, filed Dec. 10, 2005, titled “Systems and Methods for Entry into a Network Event;” and U.S. Provisional Patent Application Ser. No. 60/748,902, filed Dec. 10, 2005, titled “Systems and Methods for a Network Event,” which are all hereby incorporated by reference.

The present application is also related to U.S. patent application Ser. No. 11/602,758, filed Nov. 20, 2006, titled “Systems and Methods for Entry into a Network Event;” and U.S. patent application Ser. No. 11/602,878, filed Nov. 20, 2006, titled “Systems and Methods for a Network Event,” which are both herein incorporated by reference.

### BACKGROUND

1. Field of the Invention

The present invention relates generally to network events, and more particularly to third-part sponsorship of a network event.

2. Background Art

Consumers typically want to purchase goods for the lowest possible price. The expansion of communication networks such as the Internet has resulted in numerous ways to purchase goods, such as on-line purchases. Recently, some communication devices such as mobile phones and personal digital assistants allow Internet access, which provides further mobility and flexibility in purchasing goods over communication networks.

One example of purchasing goods or services over the Internet is the traditional auction offered by eBay, Inc. in San Jose, Calif. In this traditional auction, a seller sells their goods using eBay to the highest bidder to maximize the selling price. The auction is open for a period of time or when no higher bids are forthcoming. The revenues for the goods are typically limited to a highest paid bid. Besides traditional auctions, another type of auction is a reverse auction, where the goods are sold to the lowest unique bidder.

Another way consumers may obtain goods or prizes is through chance. For example, a lottery offers goods or cash prizes based on a small chance of winning to participants who have paid some form of payment to enter into the lottery. Lotteries do have the potential for generating large amount of revenues when the revenues from the participants exceed the actual value of the goods or cash prizes. However, lotteries often involve laws and regulations that limit the lotteries. The entertainment experience for the lottery participant is passive because the winner of the lottery is determined purely by chance without any active participation. There may be no sense of competition with other lottery participants because the participant does not control their own chances in winning.

In another example, a direct mailing sweepstakes awards goods or prizes based on chance to members who submit a postcard or entry form but who have not made a purchase or paid an entry fee. The costs of the goods or prizes may be covered from advertising, promotional, or marketing revenues and/or expenses. For example, many companies offer sweepstakes to draw attention to other goods or services offered by the companies. Besides sending in a postcard, the direct mailing sweepstakes has passive participation just as in lotteries, where the lucky winner is determined purely by chance. The chances of winning a sweepstakes or lottery can be miniscule and may depend on the number of participants.

### SUMMARY OF THE INVENTION

Systems and methods for third-party sponsorship of a network event are provided. An item is associated with a reverse auction. One or more marketing messages associated with a third party sponsor are communicated to a user associated with the reverse auction. An entry associated with the reverse auction is received from the user. The entry for the reverse auction is accepted.

### BRIEF DESCRIPTION OF THE DRAWINGS

FIG. 1 shows a diagram of an exemplary environment for third-party sponsorship of a network event;

FIG. 2 shows a block diagram of an exemplary event server;

FIG. 3 shows a flow diagram of an exemplary process for generating customer relations messages;

FIG. 4 shows a user participating in an exemplary reverse auction;

FIG. 5 is a flowchart for conducting a reverse auction in an exemplary embodiment;

FIG. 6 is a flowchart depicting an exemplary method for concluding a reverse auction;

FIG. 7 is a flowchart for an exemplary process for redeeming and obtaining points; and

FIG. 8 shows an exemplary digital device.

### DESCRIPTION OF EXEMPLARY EMBODIMENTS

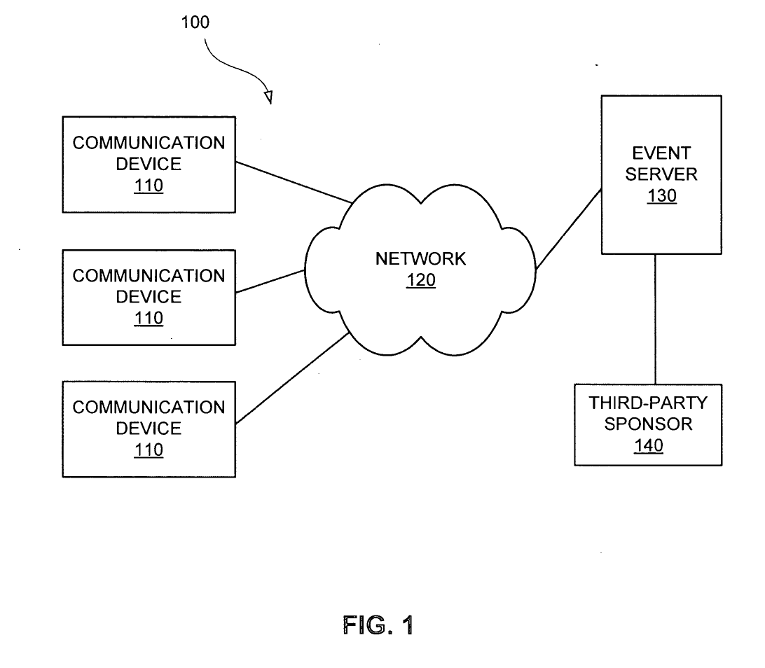

Referring to FIG. 1, a diagram of an exemplary environment for third party sponsorship 100 associated with a network event is shown. One or more communication devices, such as the communication device 110, communicate with an event server 130 via a network 120. The communication device 110 may comprise a computing device, a personal digital assistant, a cellular telephone, a laptop, a television, or any other device. The network 120 may comprise any type of network, such as the Internet, a peer to peer network, an intranet, a cable television network, a broadcast television network, and so forth.

The event server 130 may comprise any digital device (further discussed herein), such as a server computer, a network of computers, and so forth. According to some embodiments, the event server 130 is associated with a website that conducts network events, such as auctions, reverse auctions, sweepstakes, lotteries, contests, voting events, and so forth. In other embodiments, the event server 130 is a digital device that is not associated with a website.

The event server 130 may communicate with a third party sponsor 140. The event server 130 provides various network events to the communication device 110, such as lotteries, games, auctions, reverse-auctions, and so forth, as discussed herein. The communication device 110 can download data from the event server 130 and/or log into the event server 130 to participate in various network events. According to some embodiments, the event server 130 comprises a computer program including instructions for managing customer relations associated with a network event. Optionally, the event server 130 can track data associated with users.

The third party sponsor 140 may provide prize data to the event server 130. According to some embodiments, the third party sponsor 140 utilizes data from the communication device 110 in order to generate prizes. For example, the third party sponsor 140 may customize prizes in a reverse-auction for a user associated with the communication device 110. The third party sponsor 140 and/or the event server 130 may utilize data collected on the communication device 110 to customize items and/or marketing messages according to some embodiments. The third party sponsor 140 may also provide advertising, media, or any other content.

The third party sponsor 140 may provide a particular prize to be made available by the event server 130 (e.g., for auction, raffle, selling, trading, etc.) In some examples, the third party sponsor 140 provides money, goods, services, advertisements, messages, or other resources that is of value in the reverse auction.

In a further example, the third party sponsor 140 may provide reward points (e.g., Limbo points) given for every interaction by the communication device 110 with the event server 130, for interaction with the event server 130 associated with a network event, or for any other interaction or set of interactions. These reward points may be used to obtain free or lower cost (i.e., trading in reward points for a lower price) goods and services. The user may go to a physical store, website, or any provider and purchase goods and/or services in exchange for one or more of these reward points. In another example, the third party sponsor may provide one or more goods and/or services that may be purchased by the reward points.

The third party sponsor 140 may also pay for marketing messages in one or more network events. In one example, an insurance company sponsors marketing messages targeted to users who are competing for an automobile in a network event. In another example, the third party sponsor 140 may provide an advertisement for the event server 130 to communicate to users about a reverse auction. The users may then enter the reverse auction by clicking on, or otherwise interacting with, the advertisement, in one example.

The third party sponsor 140 may supplement the cost of playing the network event by paying for or discounting the price for bids. Users may be charged a cost or price for each bid the user enters. In one example, an automobile manufacturer may provide the latest model sport's car as a product in a reverse auction. The users may enter bids in the reverse auction for free, while the automobile manufacturer pays for marketing messages, such as advertisements, associated with the reverse auction. In another example, Adobe Software may pay for bids for the first 500 users for the latest version of Adobe Photoshop software. In exemplary embodiments, the third party sponsor 140 shares in revenue of one or more network events.

Those skilled in the art will appreciate that the environment for third party sponsorship 100 may represent any number of communication devices 110 in wired or wireless communication with the event server 130 over the network 120. In some embodiments, the environment for third party sponsorship 100 may comprise a telephone network. In one example, the communication devices 110 may include telephones and/or cellular telephones that communicate with the event server 130 over a telephone network 120 (e.g., by calling a phone number of the event server 130). The user may place a bid over the telephone using DTMF (Dual Tone, Multi-Frequency) or any other means such as, but not limited, to voice recognition.

In various embodiments, the network 120 may comprise several networks comprising different communication media or different communication techniques. In one example, the network 120 comprises two networks including a television network and a phone network. For example, an event server 130 may broadcast or televise a network event over the television network. A user may be able to receive the broadcast or televised network event over a television (e.g., a first communication device 110). The user may then use a second communication device 110 (e.g., a telephone) to place an entry associated with the network event with the event server 130 over the telephone network.

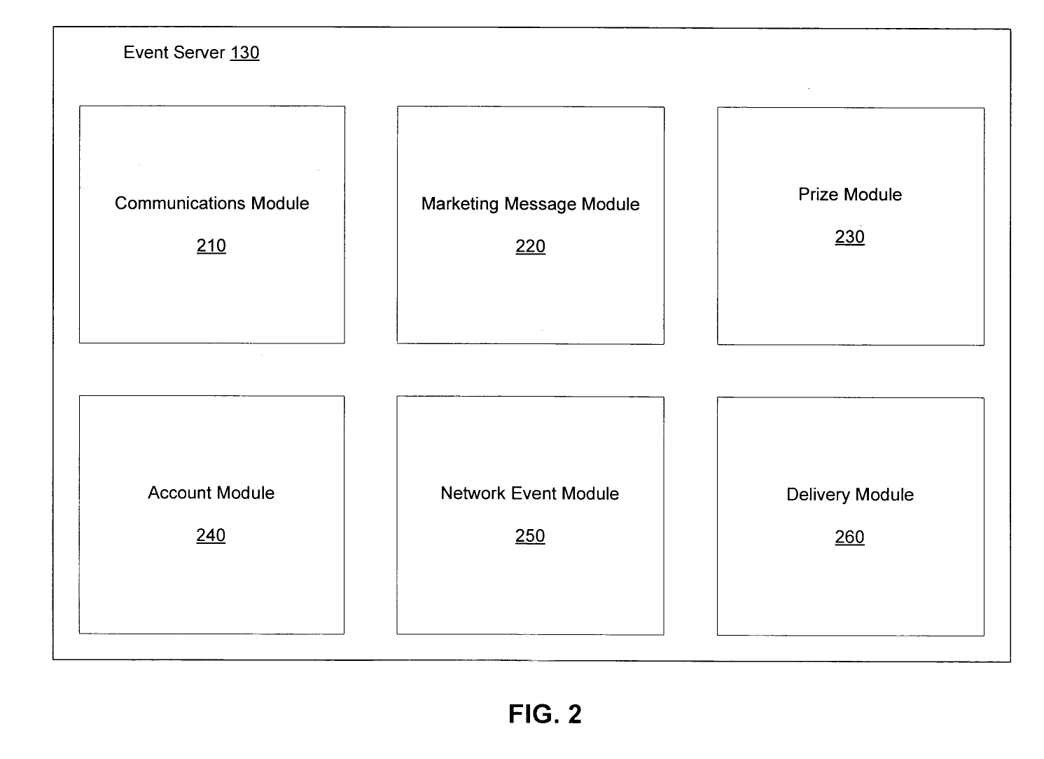

FIG. 2 shows a block diagram of an exemplary event server, such as the event server 130 shown in FIG. 1. The third party sponsor 140 may include one or more of the modules shown as part of the event server 130 in FIG. 2.

A communications module 210 is provided for facilitating communications between the event server 130 and the communication device 110. The communications module 210 may also be utilized to exchange data between the third party sponsor 140 and the event server 130. The communications module 210 may receive and/or accept entries from users for various network events, such as reverse auctions. For example, users may pay one dollar ($1.00) to place a bid in a reverse-auction with the event server 130 via the communications module 210. As discussed herein, the third party sponsor 140 may sponsor the reverse-auction so that users are not charged to place bids, according to some embodiments. The third party sponsor 140 may provide the prize or the prize may provided by another party. The third party sponsor 140 may be charged a flat fee for marketing messages delivered to users participating in the reverse-auction or the third party sponsor 140 may be charged per impression, per number of marketing messages delivered, and/or charged utilizing any other method. For example, the third party sponsor 140 may provide money and/or incentives to purchase the item to be auctioned.

A marketing message module 220 may be provided for communicating marketing messages to one or more users associated with the network event. For example, the network event may comprise an auction, a reverse auction, a lottery, a broadcast media event, or any other type of event. The marketing message module 220 may suggest marketing messages based on user data according to some embodiments. The marketing messages may comprise advertisements, images, content, media, or any other messages that may be communicated to users. In some embodiments, the marketing messages are displayed to users who can enter the network event, such as the reverse auction, by clicking on the marketing messages.

A prize module 230 may be provided for associating the item (or service) with the network event. Various network events may be ongoing at any given time. The prize module 230 may track the items and/or services associated with each of the network events. Further, the prize module 230 may also track users that participate in particular network events based on the item. For example, the prize module 230 may, optionally, determine that a large number of males between the ages of 21 and 32 participate in reverse auctions involving sports cars.

The item being offered may be based on a type associated with a network event as well. For example, the prize module 230 may determine that a large group of retirement aged women participate in lotteries. The prize module 230 may collect any type of data and any type of data from the prize module 230, any other module, or any other party may be utilized to determine the prize that is associated with the network event. According to one embodiment, a winner in a reverse auction wins the opportunity to purchase the item at a discounted price. As discussed herein, the third party sponsor 140 may provide the prize and be charged for marketing messages delivered and/or displayed to users competing for the prize.

An account module 240 may be provided for tracking account information associated with the user associated with the communication device 110. The account information may include reward points the user has accrued, bid, spent, and so forth. The account information may include information associated with various items, credits, or any other type of information related to what the user receives, bids, and/or spends in association with the network events discussed herein.

In various embodiments, a third party sponsor 140 may access the account module 240 to track or otherwise identify users associated with one or more network events. The third party sponsor 140 may then transmit advertisements to the users. In one example, the third party sponsor 140 provides a car as a prize for a network event. The third party sponsor 140 may then receive information identifying the users which place bids in the network event via the account module 240.

The third party sponsor 140 may transmit advertisements directly to the user or through the marketing messages module 220. In some examples, an advertisement is associated with a product or service of the third party sponsor 140. In other embodiments, the advertisement may comprise a message to the user that certain products or services are redeemable in exchange for reward points or to remind the user that certain prizes are provided by the third party sponsor 140. Those skilled in the art will appreciate that an advertisement may provide any message to the user.

As discussed herein, the third party sponsor 140 may sponsor the reverse auction, or any other network event, so that the users can participate in the reverse auction for free, or for no charge from the third party sponsor 140 or entity associated with the event server 130. The third party sponsor 140 may be charged for marketing messages delivered to users. The marketing messages may be customized for particular users according to some embodiments.

In some embodiments, the marketing messages module 220 tracks the users for each third party sponsor 140. The third party sponsor 140 may then command the marketing messages module 220 to transmit advertisements to the users (e.g., via the communication device 110) and track advertisement information. Advertisement information may comprise the number of advertisements that have been sent to each user, the type of advertisements that have been sent to each user, the time each advertisement was sent, and so forth. The marketing messages module 220 may also track response to advertisements and/or other marketing messages, such as click-throughs, purchases, and so forth.

In various embodiments, the marketing messages module 220 accesses an advertisement storage to retrieve an advertisement to send to a user. In one example, the advertisement storage comprises one or more advertisements associated with one or more of third party sponsors 140 and/or one or more network events. The advertisement storage may be within the event server 130 or may be in a different server (not depicted).

The marketing messages module 220 may also coordinate with a third party advertisement webserver. In one example, the marketing messages module 220 may supply user information (e.g., user identity, associated network events, prizes of associated network events, and/or email address of a user) to the third-party advertisement webserver which may then select an advertisement to send to a user. An advertisement may include, but is not limited to, data, voice, music, video, images, and/or text.

In various embodiments, the marketing messages module 220 may provide advertisement recommendations and/or the user information. In one example, the marketing messages module 220 collects or tracks user information regarding individual users. Based on the user information, such as the network events the user enters, user registration information, products purchased by the user using points, past advertisements the user may have been interested in and so forth, the marketing messages module 220 may perform statistical analysis and/or provide a recommendation of which advertisement to send to the user. The marketing messages module 220 may also provide the user information to the third party sponsor 140.

A network event module 250 may also be provided for coordinating the network events. For example, the network event module 250 may communicate with the communications interface 210 to determine which bids in an auction or a reverse auction qualify to win the auction or the reverse auction. More than one winner may be selected by the network event module 250. Further, the winner(s) may receive incentives as prizes, such as by the third party sponsor 140. For example, the winner(s) may receive points as a prize for spending, voting, bidding, and so forth in another network event.

The network event module 250 may also associate and/or accept a fee for each entry. The fee may be split with the third party sponsor 140. For example, the third party sponsor 140 may receive ten percent (10%) of each entry fee in exchange for providing the item, such as a car, associated with the network event. As discussed herein, each entry may be free to the users and the third party sponsor 140 may be charged for advertisements associated with the network event, such as the reverse auction.

A delivery module 260 may be provided for providing one or more items and/or services to the users. The one or more items may include tangible goods, virtual goods (e.g., ring tones), or any other type of goods. The delivery module 260 may notify the user, such as the winner of the network event, of the items being mailed or otherwise delivered to the user. The delivery module 260 may deliver the items via email or other electronic notification system. For example, the delivery module 260 may credit points to the user's account via the account module 240 and inform the user of the credited points. The delivery module 260 may provide discounts or coupons to the user as a prize, according to some embodiments.

Although various modules are shown in FIG. 2 as comprising the event server 130, fewer or more modules may comprise the event server 130 and still fall within the scope of various embodiments. For example, a profile database (not shown) may be provided for storing information about users associated with the communication devices 110.

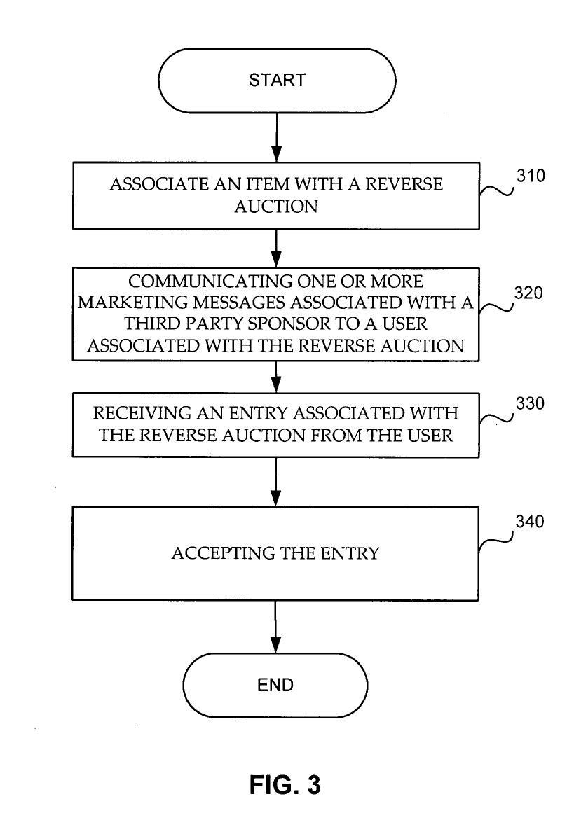

FIG. 3 is a flow diagram of an exemplary process for third party sponsorship of a network event. At step 310, an item is associated with a reverse auction. As discussed herein, a third party may supply an item, such as a car, for users to bid on in a reverse auction network event type. The item may comprise a product, such as a plasma television or a service. Any type of item and any type of network event may be associated with one another. According to some embodiments, the network event is a competition among performers (e.g., the competition between performers in a television show) and the third party sponsor hosts the network event. Users may then bid or vote for the performers at no charge, according to some embodiments, while the third party sponsor 140 may be charged for advertising to the users.

At step 320, one or more marketing messages associated with a third party sponsor are communicated to a user associated with the reverse auction. The marketing messages may be communicated to the user by the event server 130 or from the third party sponsor 140 according to some embodiments.

At step 330, an entry associated with the reverse auction is received from a user. The entry may be associated with a fee, such as when the user pays two dollars ($2.00) to place bids in an auction or the entry may be free or associated with a nominal charge, according to other embodiments. The entry may comprise a vote or a turn in a game according to some embodiments.

At step 330, the entry for the reverse auction is accepted. The event server 130 may accept a fee for the entry, accept information about the user submitting the entry, accept a vote from a user, and so forth. Any type of entry may be accepted. According to some embodiments, the third party sponsor 140 may share the fee for the entry with another party, such as the party associated with the event server 130.

In some embodiments, advertisements may be delivered to the user in response to accepting the entry from the user. As discussed herein, the third party sponsor 140 may be charged for the marketing messages delivered, displayed, or otherwise communicated to the user. According to some embodiments, at least one point is accumulated into a point total for the user in response to accepting the entry.

For example, if the user pays two dollars to place bids in an auction, the user may receive ten points. The user may then utilize those points to purchase goods at one or more vendors. The user may also utilize the points to vote in a broadcast media event. Any use of the points is within the scope of various embodiments.

In exemplary embodiments, the user enters the reverse auction for free. The third party sponsor 140 provides the prize being bid on in the reverse auction and/or pays for marketing messages that the event server 130 communicates to the users participating in the reverse auction. More than one third party sponsor 140 may sponsor the reverse auction according to some embodiments.

According to other embodiments, a user pays a fee and receives one or more points and a bid into a network event. The retail value of points received by a user may be equivalent to the fee. Points are further discussed in U.S. patent application Ser. No. 11/602,917, filed Nov. 20, 2006, titled, “Systems and Methods for Using Points with a Network Event” which is incorporated by reference herein.

Although FIG. 3 shows associating an item from the third party sponsor 140 with the reverse auction, any type of third party sponsorship may be provided. For example, the third party may provide advertising or production associated with the network event, rather than or in addition to the prize or item. According to some embodiments, prizes are not associated with the network event, such as when a user utilizes points to vote for candidates associated with a broadcast media event or when a user receives incentives to participate in other network events.

A network event is an event whereby users may access the event via various networks such as the Internet, public switched telephone networks (PSTN), and wireless networks. In one embodiment, the network event comprises a contest, game, or sweepstakes, such as a reverse auction for a product including a good or service. A reverse auction is an event which is set up in the style of an auction, whereby the product will be awarded to the user that has the lowest unique entry or bid. The lowest unique bid is the lowest bid for the product that has not been selected by one or more other users.

For example, a reverse auction may receive the following bids from one or more users:

Bid 1: $1.22;

Bid 2: $1.22;

Bid 3: $1.23;

Bid 4: $1.23;

Bid 5: $1.24;

Bid 6: $1.25;

Bid 7: $1.25; and

Bid 8: $1.26.

In this example, Bids 1 and 2, which comprise bids of $1.22, are lower than the other six bids. Even though Bids 1 and 2 are the lowest bids, however, neither is unique. The next lowest bids are Bids 3 and 4. Like Bids 1 and 2, Bids 3 and 4 are equal to each other, and are, therefore, not unique. Bid 5, which comprises a bid of $1.24, is both unique and is lower than any other unique bid. Therefore, Bid 5 is the lowest unique bid.

In some embodiments, the user that has the lowest unique bid can win the prize outright, purchase the prize at the price that is the lowest unique bid, purchase the prize in exchange for points, or purchase the prize at a different price (e.g., discounted price).

Individual reverse auctions may require bids to be made in a particular currency (e.g., US dollars or Euros). In other embodiments, specific reverse auctions may allow bids to be made in two or more different currencies. Bids within a reverse auction are not limited to currency. In one example, users may bid points or any other countable units.

If the successful user is unable to obtain the prize (i.e., lack of funds), a user with the next lowest unique bid may be offered the opportunity to purchase or win the prize. This process continues until the user with the next lowest unique bid purchases or wins the prize. If there are no lowest unique bids left, a sponsor can choose the winner randomly from all eligible entries received. In exemplary embodiments, the sponsor is any entity that is associated with the administration of the prize and/or the reverse auction.

In addition to the main prize or product, other prizes, products, or points may be awarded in a game for activities other than the lowest unique entry or bid. For example, prizes, products, or points may be awarded for playing a lucky number, being the Nth entry, being the Nth player, being the Nth new member or player, or collecting N reward points.

In some embodiments, the network event is a game wherein a winner is a user that submits the highest unique entry without going over a given value. In one example, users can submit entries containing the highest unique value without going over $1,000. One user may submit an entry for $999. If a second user also submits a play for $999, then neither entry is unique. As a result, the winning entry is the closest unique entry to $999.

In other embodiments, the network event is a game wherein the winner is a user that submits the closest unique entry to a given value. In one example, users can submit entries above or below the given value. The closest unique entry may be the winning entry. If there are two closest unique entries (e.g., one entry is less than the given value and the other entry is more than the given value), then multiple prizes may be awarded.

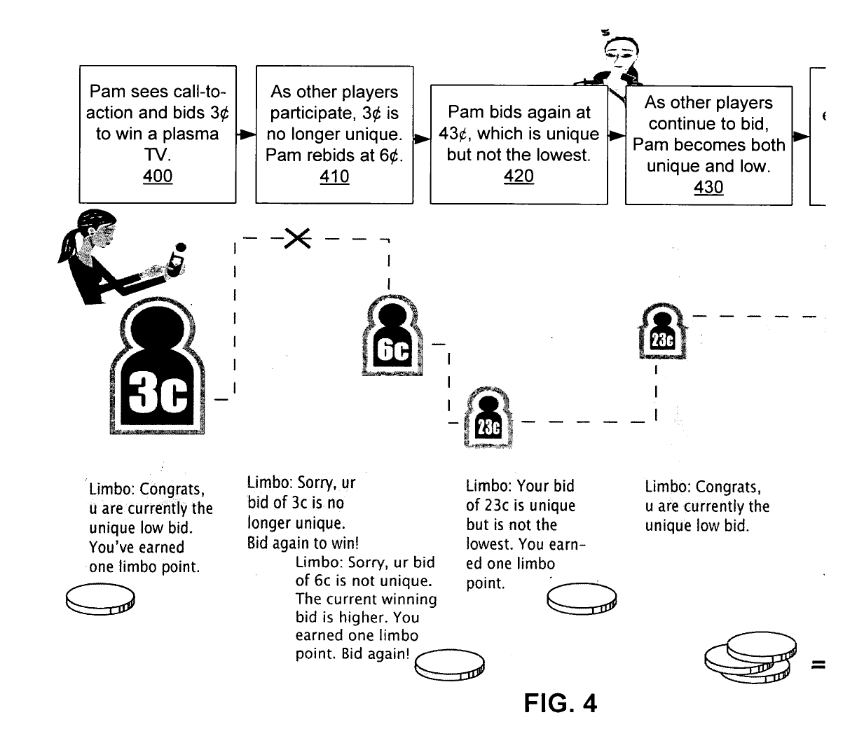

FIG. 4 shows a user participating in an exemplary reverse auction. In step 400, Pam, a user, sees a call-to-action and bids 3¢ to win a plasma TV. As discussed herein, the plasma TV is an example of a prize that may be provided by the third party sponsor 140. The call-to-action may be any message or image that invites or encourages one or more users to participate in the reverse auction. In one example, the call-to-action is a message sent to any device capable of receiving the message. The device may be a cellular phone, computer, laptop, personal digital assistant, radio, television, or any other device capable of browsing the web and/or receiving a message to enter into the reverse auction. In one example, the call-to-action is an advertisement on a web site. The call-to-action may be any message or image that invites or encourages one or more users to participate in the reverse auction.

In the present example, Pam completes her bid of 3¢ on her cellular phone. As discussed herein, Pam may submit the bid for free or she may pay an entry fee. The third party sponsor 140 may pay for the prize and/or be charged for marketing messages, such as advertisements, that may be sent to Pam. Pam then receives a message on her cellular phone indicating the status of the bid as well as whether Pam has earned a point. In some embodiments, the message or words in the message may be shortened, abbreviated, and/or truncated to display information on a smaller screen of the digital device. In one example, the message may state, “Congrats, u are currently the unique low bid. You've earned one Limbo point.”

As other players participate, 3¢ may no longer be unique. As a result, Pam may receive a message on her cellular phone indicating that her bid is no longer unique. In one example, the message may state, “Sorry, ur bid of 003 is no longer unique. Bid again to win!”

In step 410, Pam re-bids at 6¢ after finding out that her original bid is no longer unique. Although a user is not required to bid multiple times in a reverse auction, if the user's bid is not the lowest unique bid, the user no longer has a chance to win the auction. Upon Pam's re-bid of 6¢, Pam may receive another message indicating that 6¢ is not unique as well as any other information that may encourage her to bid again. In one example, the message may state, “Sorry, ur bid of 6¢ is not unique. The current winning bid is higher. You earned one Limbo point. Bid again.”

In step 420, Pam bids again at 23¢ which is unique but not the lowest. As a result, Pam may receive a message indicating that 23¢ is not the lowest bid. In one example, the message may state, “Your bid of 23¢ is unique but is not the lowest. You earned one Limbo point.”

In step 430, as other players continue to bid, Pam's bid becomes both unique and low. Pam may receive a message indicating that Pam's bid of 23¢ is now the unique lowest bid. In one example, the message may state, “Congrats. U are currently the unique low bid.” In this example, Pam's bid is unique but not low. As others bid, another user may choose to bid the same amount as the lowest unique bid. As a result, that bid is no longer unique, and, therefore, the next lowest unique bid may win the reverse auction.

In step 440, the auction window expires and Pam becomes the winner. In various embodiments, the reverse auction ends after a predetermined time, when a predetermined currency is bid, or when a predetermined number of bids is reached. Once the end of the reverse auction is reached, the winner may receive a message indicating that they have won the auction and any other information associated with receiving the prize. For example, the delivery module 260 discussed herein may send the message regarding the prize. In one example, the message may state, “Congrats! Your bid of 23¢ for the plasma TV was the winning bid! Visit limbo-mobile.com to claim your prize! Ref. JRB756.”

As discussed herein, revenue generated from bidders, such as Pam in the example in FIG. 4, may be shared with the third party sponsor 140. The third party sponsor 140 may receive a percentage, a set amount, a percentage up to a specified amount, or any other fee. In other embodiments, revenue may not be directly generated from bidders, but rather the bidders' entries may be free and the third party sponsor 140 may sponsor the reverse auction by providing the prize and/or paying for marketing messages directed to the bidders.

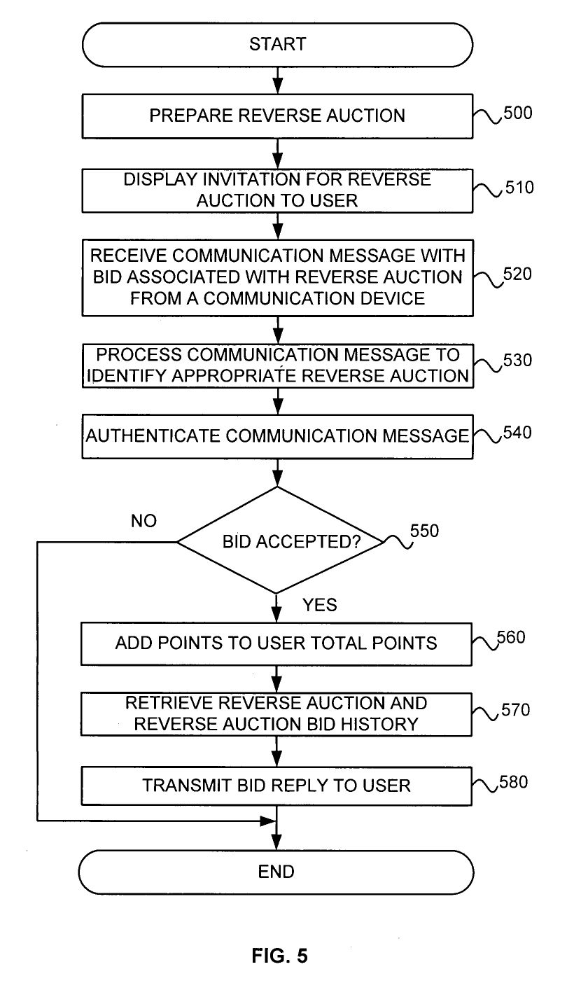

FIG. 5 is a flowchart for conducting a reverse auction in an exemplary embodiment. In one example, the reverse auction comprises a network event. In step 500, the event server 130 (FIG. 1) prepares the reverse auction. In preparing for a reverse auction, an event provider, such as the event provider associated with the event server 130, identifies the product for the reverse auction and sets up terms and conditions for the auction. Once the prize is identified, the reverse auction may be initiated. In addition to the identification of the prize, the event provider may take possession of the prize, license the prize, or enter into an agreement with a third party to provide one or more prizes to the winner of the reverse auction, such as by having the third party sponsor 140 provide the item to associate with the reverse auction.

In step 510, the event server 130 displays an invitation for the reverse auction to a user. In some embodiments, the invitation can be a link, image, or icon on a website that identifies the reverse auction. The user may be encouraged or invited to bid on a particular prize within the reverse auction. In other embodiments, messages inviting users or advertising one or more reverse auctions can be transmitted over the radio, to the user's cell phone, personal digital device, computer, laptop, or any other communication device 110 (FIG. 1). Alternatively, a user may, on their own accord, go to an auction site on the Internet, and search for an auction for a particular item of interest.

In step 520, the event server 130 receives a communication message with a bid associated with the reverse auction from a communication device 110. As discussed herein, the bid may comprise an entry associated with the network event, the network event comprising the reverse auction in the example. Any communication device 110 may send the communication message to the event server 130. In one example, the user sends the communication message from a website to the event server 130. One example of the communication message comprises elements including a user identification, a specific auction, and a bid for the specific auction. In some embodiments, the communication message also comprises a payment for the bid. For example, the user may include a credit card number, which is charged one dollar in return for the option to place a bid in a specific reverse auction.

In step 530, the event server 130 processes the communication message to identify the appropriate reverse auction. The event server 130 may confirm that the particular reverse auction identified in the communication message is a reverse auction that has not ended. In some embodiments, a plurality of reverse auctions are conducted concurrently. The communication message may comprise both a bid and identification of a particular auction item or prize. If the user wishes to bid in multiple auctions, the user may send multiple communication messages, one for each bid. In other embodiments, the user may send a single communication message to bid on multiple auctions.

In step 540, the event server 130 authenticates the communication message. Each message may identify the user who bids, a payment for the option to bid, and a particular reverse auction. The event server 130 can confirm, authenticate, authorize, and/or verify the user identified in the communication message, the payment for the option to bid, and the particular reverse auction.

In one example, the event server 130 verifies a user identified in the communication message. If the user has an existing account with the event provider of the reverse auction, the user can include a password or other information to confirm that the user identified in the communication message is the same user identified in the account. As discussed herein, the account module 240 may access user account information according to some embodiments. In some embodiments, if the user does not have an account, the event server 130 can initiate and create an account or record to track the bids made by the user to the reverse auction. For example, a user may transmit their name and drivers license number to the event server 130. The event server 130 can then create the account associating the user's name with the driver's license.

In some embodiments, the account module 240 may establish a secure communication (e.g., SSH) with the user. In various embodiments, the account module 240 utilizes one or more encryption keys to authenticate communications received by the user, confirm bids, confirm an entry into a network event, or encrypt messages to the user.

The communication message may include a payment to bid in the reverse auction. In one example, the user includes a credit card number from which payment may be obtained. The event server 130 can confirm and/or charge a fee from a credit card in exchange for the option to bid in the reverse auction. The user may pay for the option to bid in any number of ways.

The communication message may also identify a particular reverse auction. The event server 130 may confirm that the particular reverse auction identified in the communication message is an actual reverse auction that has not ended. If the particular reverse auction identified in the communication message does not exist or has already ended, the event server 130 may send a message to the user requesting that the user select another reverse auction.

In step 550, the event server 130 determines if the bid is accepted or rejected. If the event server 130 cannot verify the user, then the event server 130 may reject the bid. In other embodiments, if the payment is included in the communication message and the payment is insufficient or cannot be charged, then the event server 130 may also reject the bid. If the event server 130 rejects the bid, the process of FIG. 5 ends.

In step 560, the event server 130 adds points to the user's total points. For each bid the user makes, the user may receive one or more points. In some embodiments, the event server 130 displays a user interface for the event provider to customize the awarding of points such as how many points are awarded for bids. The event server 130 can create accounts to track the user's bids and/or user's total points. As discussed herein, the account module 240 may track the user's point totals. For example, the account module 240 may use an account for one reverse auction to track each individual user, associate each point with a user, and associate each bid with a user. In another example, the account module 240 may establish one or more separate accounts for each user.

In further some embodiments, points may be awarded for activities other than placing a bid. For example, points may be awarded for bidding a lucky number, being the Nth bid made, being the Nth bidder, being the Nth new member, or collecting N reward points. In other embodiments, the user may not be charged for placing a bid and points may not be awarded to the user when the bid is placed.

In step 570, the event server 130 retrieves the reverse auction and the reverse auction bid history. A reverse auction bid history is a log of all bids and associated users for one or more particular reverse auctions. In one example, the user bids within a particular reverse auction for an Apple Ipod™. If the bid is accepted, the particular reverse auction and the particular reverse auction bid history is retrieved from a storage (e.g., storage within the event server 130) and the new bid is logged.

In step 580, the event server 130 transmits a bid reply to the user. The bid reply may inform the user that the user's bid is the lowest unique bid, the bid is not unique, the bid is unique but is not the lowest, or any other message.

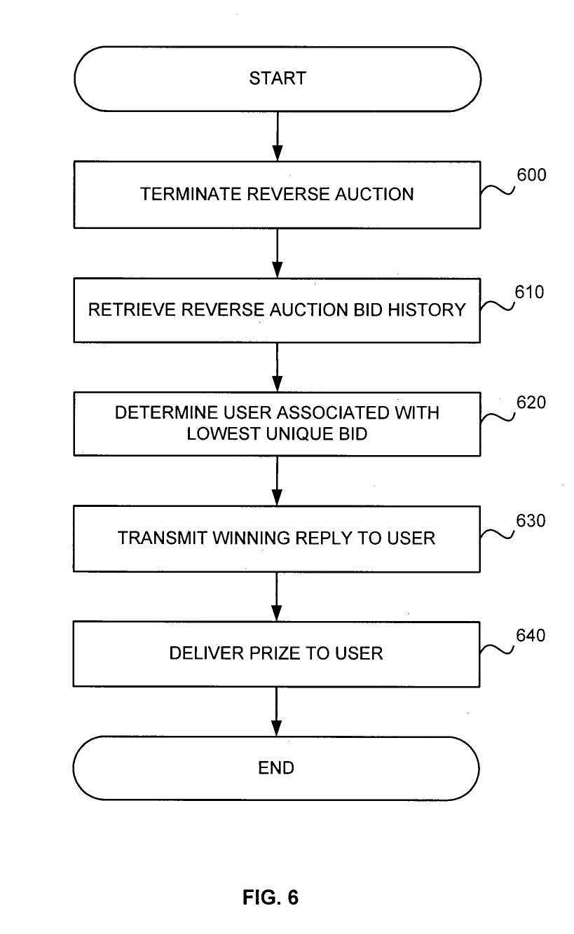

FIG. 6 is a flowchart depicting an exemplary method for concluding a reverse auction. In step 600, a predetermined event may conclude a particular reverse auction. The predetermined event may comprise the termination of a predetermined period of time, receiving a predetermined number of bids, receiving bids from a predetermined number of users, receiving a predetermined bid, or any other measure.

In step 610, the event server 130 retrieves the reverse auction bid history. In some embodiments, one or more reverse auction bid histories for a particular reverse auction is retrieved from a cache or other storage medium located on a server, such as the event server 130 or communication device 110. Once the reverse auction bid history is retrieved, the event server 130 determines the user associated with the lowest unique bid in step 620.

The user with the lowest unique bid after the reverse auction has concluded may be the winner of the reverse auction. In other embodiments, the winner of the reverse auction may be a second lowest unique bid after the reverse auction has concluded. The event server 130 may determine the winner in any number of methods. As discussed herein, the winner may win the item provided by the third party sponsor 140, such as a plasma screen television.

In step 630, the delivery module 260 transmits a winning reply to the user. The user may receive the winning reply over any communications device, such as the communications device 110 discussed in FIG. 1. The winning reply may alert the user that they have won the reverse auction and further instruct the user how to receive the prize. The winning reply may also include advertisements for additional reverse auctions. The event server 130 may also send e-mails to the other bidders notifying them that their bid was unsuccessful and providing an update total of their points.

In step 640, the prize is delivered to the user. In other embodiments, the user may claim the prize directly. For example, the user may receive a password from the delivery module 260 that enables the user to receive or download songs or media. The user may also receive prizes by mail or delivery. The user may also physically appear at an appropriate location to receive the prize. The user may receive the prize in any number of methods, as discussed herein.

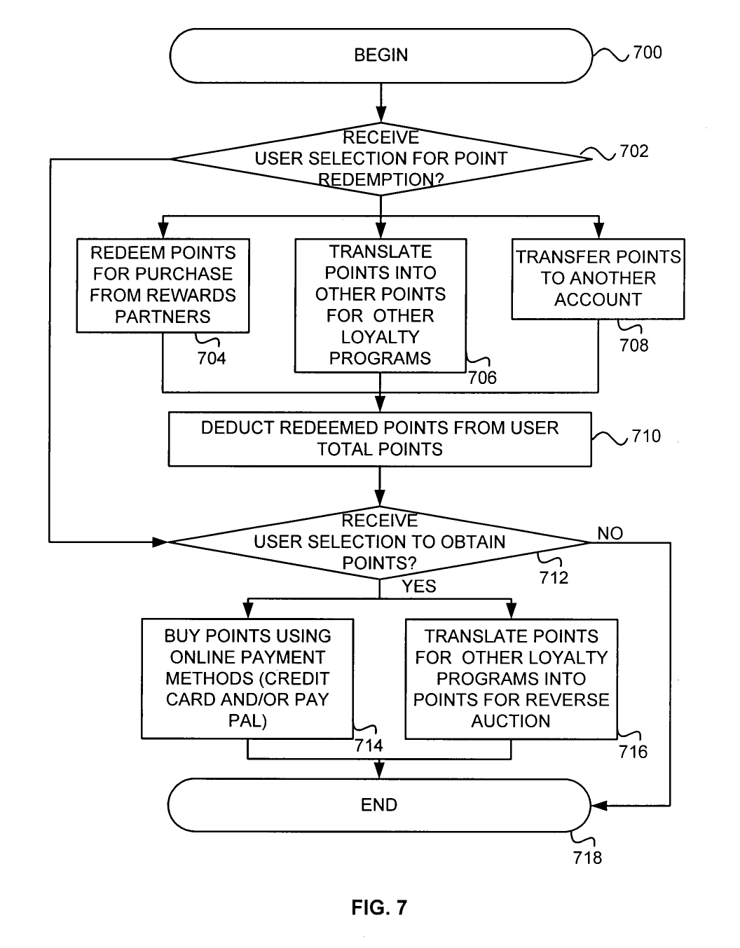

FIG. 7 is a flowchart for an exemplary process for redeeming and obtaining points. The points may be redeemed to purchase goods, services, or discounts. Some examples of goods that can be purchased by points are ringtones, wallpapers, games, subscriptions (i.e. mobile service, satellite radio, Netflix, Blockbuster, newspaper, and magazine), and other type of consumer products.

The network event or game provider may partner or agree with another goods or service provider to offer additional goods and services, such as items by the third party sponsor 140, as discussed herein. Some examples of the goods and/or service provider are in the retail and travel industry. Partnering with other goods and/or service providers may create access to and marketing exposure to a large number of consumers, who may participate in a reverse auction. Also, the website of the networked event or game provider may act as a storefront for the goods and/or service providers to sell and market their goods and/or services. Also, the event or game provider may keep track of redemption of points to provide marketing information for the goods and/or service providers.

The points may also be exchanged for other loyalty programs of goods and/or service providers such as frequent flier miles from airlines. The points may also be exchanged for coupons, discounts, and vouchers for future purchases of goods and/or services. Points may also be redeemed to obtain more plays in the game or to make a charitable donation.

Points are, in one embodiment, accumulated when a user submits an entry to play a contest, game, or sweepstakes. However, in some cases, a user may want to redeem their points but has insufficient points in their balance for the purchase or exchange. The user can then purchase more points by using a credit card or an on-line payment method such as PayPal. In some embodiments, the event server 130 may allow a user to combine their point totals with other users into groups to aggregate their points for redemption.

In exemplary embodiments, a value of one point is greater than or equal to the cost to enter the network event. In one example, a user places a bid with a cellular telephone and is subsequently charged $1.00 (e.g., via reverse SMS). In return, the user enters into a reverse auction and receives one point. The single point may have a value equal to or greater than $1.00 because the single point may be redeemed for a prize or product worth $1.00 or more (e.g., a ringtone valued at $1.00.) In other examples, multiple points may be redeemed for one or more prizes or products. In other embodiments, the single point may be redeemed for a prize or product worth less than the cost to enter the network event. In still further embodiments, the user enters into a reverse auction without paying for the entry, as discussed herein.

FIG. 7 begins in step 700. In step 702, the event server 130 checks whether the user selection for point redemption is received. If no user selection for point redemption is received, the process proceeds to step 712. If a user selection for point redemption is received, the event server 130 proceeds to one of steps 704-708 for different options in redeeming points.

In step 704, the event server 130 redeems points for purchase of goods and/or services from rewards partners. Prior to the redemption, the event server 130 may display a complete shopping experience to the user to assist in redeeming their points. For example, the event server 130 can display ten items that the user can purchase with their points. Items can be highlighted if the user can afford the items based on their points available. The event server 130 may also display a list of reward partners that the user can redeem their points for. The event server 130 may display rewards partners or items based on the profile in the user's account and total number of points available. The items can be shown in the amount of point needed to purchase and in the amount of real money needed.

In step 706, the event server 130 translates the points into other points for other loyalty programs. In step 708, the event server 130 transfers the points to another account. In step 710, the event server 130 deducts the points redeemed from the user's total points in their account, such as the points stored and/or tracked by the account module 208 discussed in FIG. 2. After the redemption, the event server 130 may display or e-mail the new account balance of points.

In step 712, the event server 130 checks whether the user selection for obtaining points has been received. If no user selection for obtaining points has been received, the process ends in step 718. If the user selection for obtaining points has been received, the event server 130 proceeds to step 714 or step 716 depending on the user selection of how the user wants to obtain points.

In step 714, the event server 130 buys points using an online payment such as PayPal or a credit card from the user. Payment can also be made by Premium SMS services for mobile phones. In step 716, the event server 130 translates points for other loyalty programs into points for the user account. FIG. 7 ends in step 718.

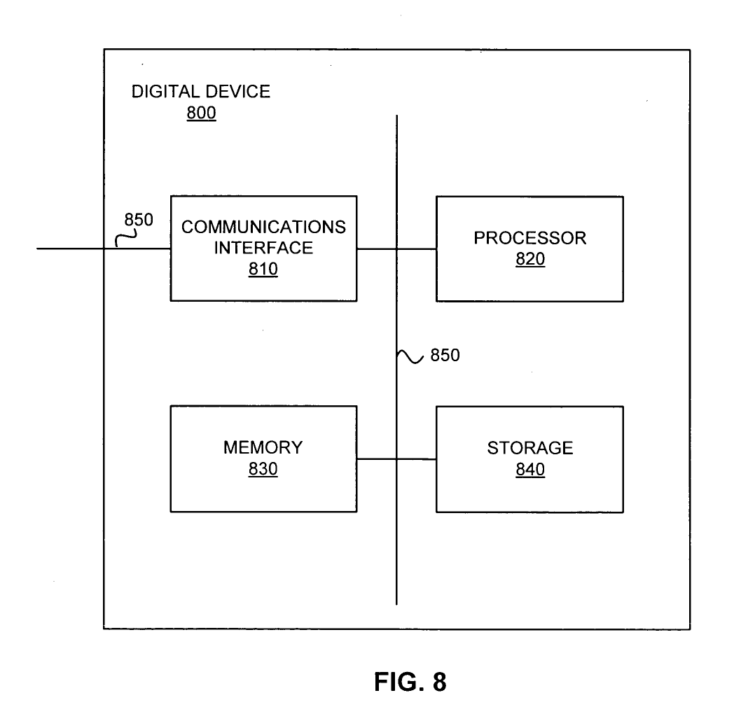

FIG. 8 shows an exemplary digital device. The digital device may comprise the event server 130 or the third party sponsor 140 according to some embodiments. The server includes a communications interface 810, a processor 820, a memory 830, and storage 840, which are all coupled to the bus 850. The bus 850 provides communications between the communications interface 810, the processor 820, the memory 830, and the storage 840.

The processor 820 executes instructions. The memory 830 permanently or temporarily stores data. Some examples of the memory 830 are RAM, ROM, and flash memory. The storage 840 also permanently or temporarily stores data. Some examples of the storage 840 are hard disks and disk drives.

The communications interface 810 communicates over the network 120 with the communication devices 110 (see FIG. 1).

The embodiments discussed herein are illustrative. As these embodiments are described with reference to illustrations, various modifications or adaptations of the methods and/or specific structures described may become apparent to those skilled in the art.

The above-described functions can be comprised of instructions that are stored on storage media (e.g., computer readable medium). The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media.

While various embodiments have been described above, it should be understood that they have been presented by way of example only, and not limitation. For example, any of the elements associated with the event server 130 may employ any of the desired functionality set forth hereinabove. Thus, the breadth and scope of a preferred embodiment should not be limited by any of the above-described exemplary embodiments.

What is claimed is:

1. A method for providing third party sponsorship of a reverse auction comprising:
associating an item with a reverse auction;
communicating one or more marketing messages associated with a third party sponsor to a user associated with the reverse auction;
receiving an entry associated with the reverse auction from the user; and
accepting the entry.

2. The method recited in claim 1, further comprising accumulating at least one point for the entry into a point total for the user in response to accepting the entry.

3. The method recited in claim 1, wherein the third party sponsor comprises a broadcast media producer.

4. The method recited in claim 1, wherein the third party sponsor provides the item.

5. The method recited in claim 1, further comprising associating a fee with the entry.

6. The method recited in claim 5, further comprising sharing the fee with the third party sponsor.

7. The method recited in claim 1, further comprising charging the third party sponsor for the one or more marketing messages.

8. The method recited in claim 1, wherein the item comprises a product.

9. The method recited in claim 1, wherein the item comprises a service.

10. The method recited in claim 1, further comprising delivering one or more advertisements in response to accepting the entry.

11. A system for providing third party sponsorship of a reverse auction comprising:
a prize module configured to associate an item with a reverse auction;
a marketing messages module configured to communicate one or more marketing messages associated with a third party sponsor to a user associated with the reverse auction; and
a communications module configured to receive an entry associated with the reverse auction from a user and to accept the entry for the reverse auction.

12. The system recited in claim 11, further comprising an account module configured to accumulate at least one point for the entry into a point total for the user in response to accepting the entry.

13. The system recited in claim 11, wherein the third party sponsor comprises a broadcast media producer.

14. The system recited in claim 11, wherein the third party sponsor provides the prize.

15. The system recited in claim 11, further comprising associating a fee with the entry.

16. The system recited in claim 15, further comprising sharing the fee with the third party sponsor.

17. The system recited in claim 11, further comprising charging the third party sponsor for the one or more marketing messages.

18. The system recited in claim 11, wherein the item comprises a product.

19. The system recited in claim 11, wherein the item comprises a service.

20. The system recited in claim 11, further comprising delivering one or more advertisements in response to accepting the entry.

21. A computer readable medium having embodied thereon a program, the program being executable by a processor for performing a method for providing third party sponsorship of a reverse auction comprising:
associating an item with a reverse auction;
communicating one or more marketing messages associated with a third party sponsor to a user associated with the reverse auction;
receiving an entry associated with the reverse auction from the user; and
accepting the entry.

22. The computer program recited in claim 21, further comprising accumulating at least one point for the entry into a point total for the user in response to accepting the entry.

23. The computer program recited in claim 21, wherein the third party sponsor comprises a broadcast media producer.

24. The computer program recited in claim 21, wherein the third party sponsor provides the prize.

25. The computer program recited in claim 21, further comprising associating a fee with the entry.

26. The computer program recited in claim 25, further comprising sharing the fee with the third party sponsor.

27. The computer program recited in claim 21, further comprising charging the third party sponsor for the one or more marketing messages.

28. The computer program recited in claim 21, wherein the item comprises a product.

29. The computer program recited in claim 21, wherein the item comprises a service.

30. The computer program recited in claim 21, further comprising delivering one or more advertisements in response to accepting the entry.
